(19) United States
(12) Patent Application Publication
(10) Pub. No.: US 2002/0134935 A1
(43) Pub. Date: Sep. 26, 2002

(54) Inspection method to check contact hole open after contact etching

(76) Inventors: Ming-Chung Liang, Pingtung (TW); Shin-Yi Tsai, Hsinchu (TW)

Correspondence Address: POWELL, GOLDSTEIN,, FRAZER & MURPHY LLP, P.O. BOX 97223, WASHINGTON, DC, 20090-7223, US

(21) Appl. No.: 09/894,216

(22) Filed: Jun. 28, 2001

(30) Foreign Application Priority Data
Mar. 26, 2001 (TW) 90107114

(51) Int. Cl. G01N 23/225

(52) U.S. Cl. 250/307; 250/310

(57) ABSTRACT

The present invention provides an inspection method including the following steps. First, the wafer, after contact etching, will carry out a SEM's (scanning electron microscope) scanning electron beam, wherein the amplification factor is about 500 to 5000 and the scanning time is about 5 to 10 second. The surface of silicon, silicon oxide, or other insulating materials may display different color after processing electron beam scanning due to the different material charging effect. Therefore, the etching result may be determined by comparing the color shown on the SEM photograph.

### FIELD OF THE INVENTION

The present invention relates to an inspection method, and more specifically, to the inspection method to check the etching result according to the presenting different color.

### BACKGROUND OF THE INVENTION

From the first invention of the integrated circuit in 1960, the number of devices on a chip has increased at an explosive rate. The integrated circuits' function, capacity, and operational speed have been greatly improved with the progress of the semiconductor integrated circuits into ULSI (ultra large scale integration) or at an even higher level. The single semiconductor chip's capacity has increased from several thousand to hundreds of million, or even billions of devices. Thus, the manufactured chips' functional inspection and the quality control with such densely packed integrated circuits have become a quite important process in ensuring the operation and the reliability of the chips.

The operational characteristics of the semiconductor devices or the integrated circuits (IC) are significantly influenced by the etching process. If the etching process fails, i.e. the contact hole is not open, the semiconductor devices or the integrated circuits (IC) may break. Typically, this unstable (or abnormal) etching condition can be caused by, for example, wrong part installation during maintenance, poor etching condition control, personal factors, or the combination thereof. Abnormal etching condition mentioned above can result in defects in the processed wafers or a contact hole not opened. If the abnormal etching conditions are not detected until after the wafers are processed, then a large number of wafers will be wasted. Therefore, there is a need for an efficient inspection technique to detect abnormal or unstable etching conditions during processing.

### SUMMARY OF THE INVENTION

In accordance with the present invention, an efficient method of inspecting the contact hole after contact etching is provided. In one embodiment, a silicon, silicon oxide, or other insulating materials are processed by an scanning electron beam. In the SEM photograph, the surface of these materials will display different colors due to the material charging effect. The contact hole's etching result may be determined by the material's displayed color. With a scanning electron beam the wafer may be able to detect an unusual etching process. Thus, an abnormal condition in the etching process will be detected in real-time, allowing the process to be corrected before a large number of wafers are defectively processed.

The inspection method provided in the present invention includes the following steps. First, the wafer after contact etching processes an SEM's (scanning electron microscope) scanning electron beam. The surface of silicon, silicon oxide, or other insulating materials may display different color after processing electron beam scanning due to the different material charging effect. Therefore, the etching result may be determined by comparing the color shown on the SEM photograph.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a cross-section view of the contact hole formed on the semiconductor substrate structure.

FIG. 2 illustrates a cross-section view of the contact hole, dielectric remained in it, forming on the semiconductor substrate structure.

FIG. 3 is a SEM photograph showing the wafer after contact etching.

FIG. 4 is a SEM photograph showing the another wafer after contact etching.

### DETAILED DESCRIPTION OF THE PREFERRED EMBODIMENT

Without limiting the spirit and scope of the present invention, the method proposed in the present invention is illustrated with one preferred embodiment about efficiency inspecting the wafer after contact etching. People who are knowledgeable about the embodiments can apply the present invention on inspecting contact holes of different production to eliminate the possibility of the abnormal etching conditions not detected until after the wafers are processed, which will waste a large number of wafers. The usage of the present invention is not being limited by the embodiment as follows.

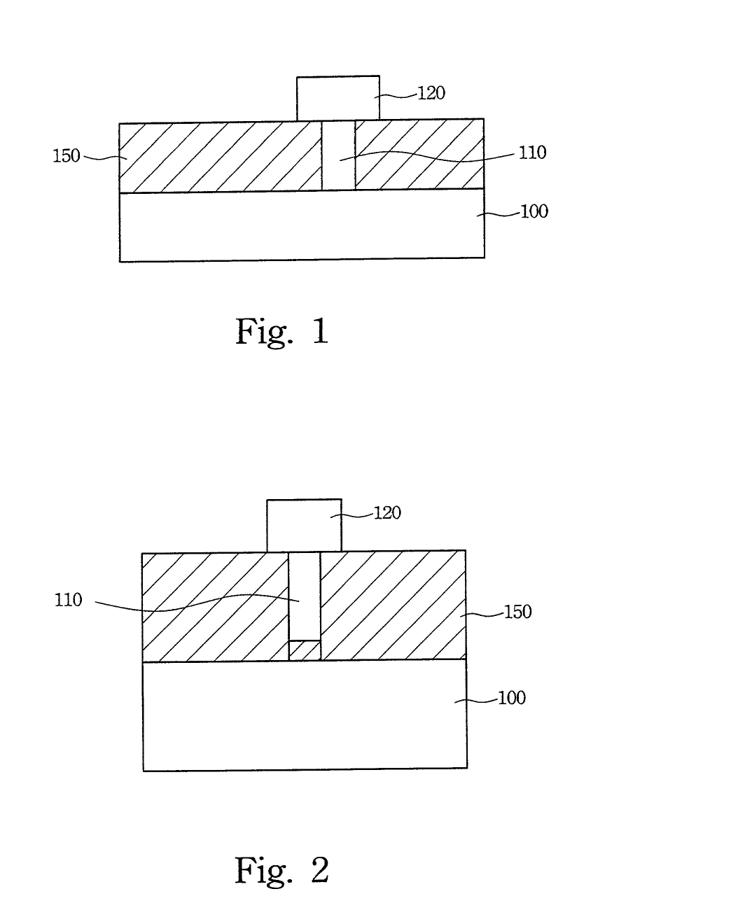

Referring to FIG. 1, it illustrates a silicon substrate 100 wherein the structure of MOS transistor has not been shown in the figure. The metal line 120 couples with the source or drain of the MOS transistor on the substrate 100 via the contact hole 110 to pass through the dielectric layer 150, wherein the pattern of the contact hole 110 is firstly transferred to the photoresist (not shown in the figure) which is formed on the dielectric layer 150 by the photolithography process. Then, an anisotropic dry etching process is applied on the dielectric layer 150 to form a contact hole 110. Referring to FIG. 2, when the abnormal etching process happens such as some dielectric material still remaining in the contact hole 110, the metal line 120 will isolate the source or drain of the MOS transistor, which will cause the whole device to fail. Thus, if the abnormal etching conditions are not detected until after the wafers are processed then a large number or wafers will be wasted. The present invention provides an efficient inspection technique to detect abnormal or unstable etching conditions during processing.

The abnormal etching conditions will cause the metal contact failure. Therefore, it is very important to inspect the contact hole after contact etching. The present invention provides an inspection method including the following steps. First, the wafer after contact etching, will carry out a SEM's (scanning electron microscope) scanning electron beam, wherein the amplification factor is about 500 to 5K and the scanning time is about 5 to 10 seconds. The surface of silicon, silicon oxide, or other insulating materials may display different color after proceeding electron beam scanning due to the different material charging effect. Therefore, the etching result may be determined by comparing the color shown on the SEM photograph. When the etching process is normal, the silicon surface will be scanned by the SEM's electron beam. However, if the etching process is abnormal, which means the defined contact hole has a residual dielectric layer, the scanned part will include the surface of silicon oxide. The surface of silicon and silicon oxide will display different color after proceeding electron beam scanning due to the different material charging effect. Then, the etching result may be determined by comparing the color. If the contact hole etching process is normal, the electron beam scanning part is silicon surface which will present circular point with white color on the SEM photograph. If the contact hole etching process is abnormal, the electron beam scanning part will be the dielectric, silicon oxide, surface which will present a circular point with dark color on the SEM photograph. If the contact hole is partial etched, the electron beam scanning part will include the residual silicon oxide surface and the silicon surface which will present an irregular point with white color on the SEM photograph.

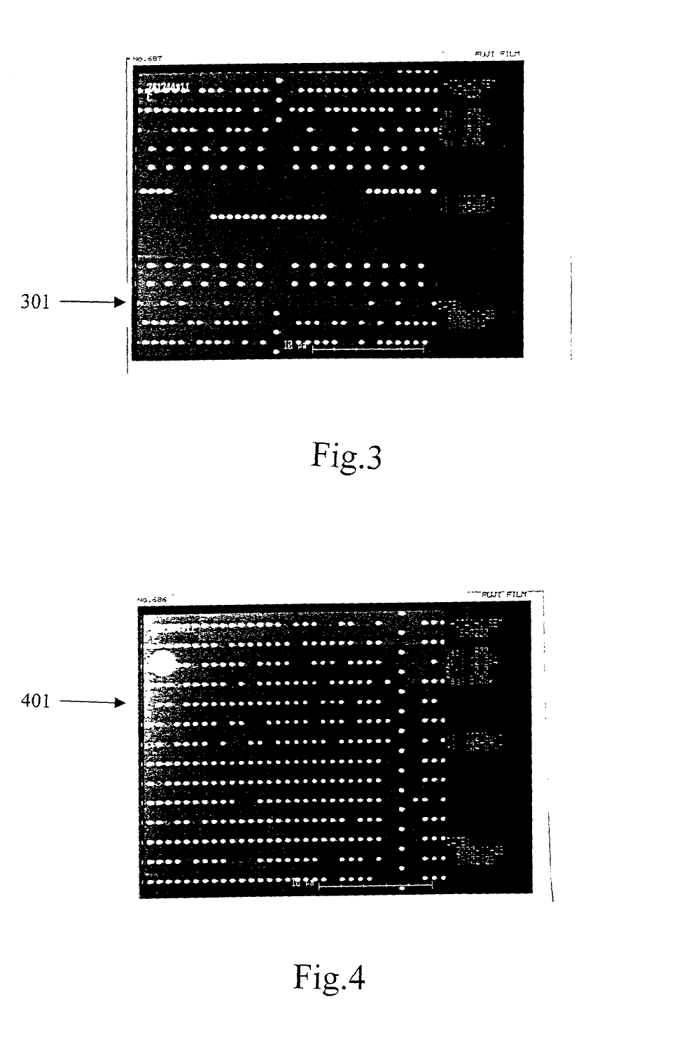

Referring to FIG. 3, it illustrates a wafer's SEM photograph after contact etching, wherein the amplification factor is 5K. There is a circular point with dark color (indicated by the arrow 301) on the SEM photograph representing the contact hole etching is abnormal. Referring to FIG. 4, it illustrates another wafer's SEM photograph after contact etching, wherein the amplification factor is also 5K. On the SEM photograph, the circular point with dark color (indicated by the arrow 401) represents the contact hole etching is abnormal. Therefore, the present invention provides an efficient inspection technique to detect abnormal or unstable etching conditions during processing, which may eliminate the large number of wafers being wasted.

As is understood by a person skilled in the art, the foregoing descriptions of the preferred embodiment of the present invention is an illustration of the present invention rather than a limitation thereof. Still more configurations and variations could be implemented by persons skilled in the art. It is intended to cover various modifications and similar arrangements included within the true scope of the appended claims. The scope of the claims should be accorded to the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A method for inspecting contact hole after contact etching, said method comprising the steps of:
performing an SEM electron beam scanning on the wafer after contact etching; and
comparing color of said a plurality of contact holes represented on the SEM photograph, if said a plurality of contact holes display different color which means some of said a plurality of contact holes etching abnormal.

2. The method of claim 1, wherein said a plurality of contact holes display different color means if said a plurality of contact holes etching process is normal, said a plurality of contact holes will display white color on the SEM photograph. If said a plurality of contact holes etching process is abnormal, said a plurality of contact holes will display dark color on the SEM photograph. If said a plurality of contact holes are partial etched, said a plurality of contact holes will display irregular white color on the SEM photograph.

3. The method of claim 1, wherein said performing an SEM electron beam scanning amplification factor is 500 to 5K.

4. A method for inspecting a contact hole after contact etching, said method comprising the steps of:
performing an SEM electron beam scanning on the wafer after contact etching; and
comparing color of said a plurality of contact holes represented on the SEM photograph;
etching process of contact holes is normal if said a plurality of contact holes display white color on the SEM photograph; and
etching process of contact holes is abnormal if said a plurality of contact holes display dark color or irregular white color on the SEM photograph.

5. The method of claim 4, wherein said performing an SEM electron beam scanning amplification factor is 500 to 5K.
